(19) United States
(12) Patent Application Publication
(10) Pub. No.: US 2008/0083676 A1
(43) Pub. Date: Apr. 10, 2008

(54) Oil Purifier System and Process

(76) Inventor: Frank DePaul, Lake Zurich, IL (US)

Correspondence Address: MICHAEL P. MAZZA, LLC, 686 CRESCENT BLVD., GLEN ELYN, IL, 60137, US

(21) Appl. No.: 11/539,970

(22) Filed: Oct. 10, 2006

(51) Int. Cl. B01D 1/00

(52) U.S. Cl. 210/774; 210/180; 159/3

(57) ABSTRACT

Improved oil reconditioning systems and methods are disclosed. One preferred system provides an oil purifier for an internal combustion engine for separating contaminants in an oil stream from the oil. The system may include a housing, an oil distributor, and a heating element. The housing may enclose a platen having an evaporation surface. The oil distributor may also be located in the housing and may be configured to receive an incoming oil stream. The oil distributor may have a discharge manifold for transforming the oil stream into a mist. The mist may be directed toward, and distributed over, at least a portion of the evaporation surface. The heating element may be in thermal communication with the platen. The evaporation surface may be heated to a temperature sufficient to volatilize the contaminants, resulting in a purified liquid oil which may be collected and reused with the engine.

### CROSS-REFERENCE TO RELATED APPLICATION

This application claims priority from co-pending application Ser. No. 10/647,093, filed Aug. 22, 2003 by DePaul, Publication No. 2005/0040077, entitled “LUBRICATING OIL RECONDITIONING DEVICE AND PROCESS,” which is hereby incorporated by reference in its entirety for all that it teaches without exclusion of any part thereof.

### FIELD OF THE INVENTION

The present invention relates generally to oil reconditioning systems and processes. More specifically, the invention relates to an improved oil reconditioning system and method in which contaminated oil is deposited on an evaporation surface and volatile contaminants are separated from the oil.

### BACKGROUND OF THE INVENTION

Commonly used oil filters for internal combustion engines generally do not remove miscible liquid contaminants from the oil. Such contaminants include, but are not limited to, water and low boiling point organic chemicals whose presence in the lubricating oil may cause engine corrosion and wear.

Oil lubricating systems for internal combustion engines that may remove such contaminants are described in U.S. Pat. Nos. 5,242,034, 5,707,515 and No. 6,083,406, each to Frank and/or Michael DePaul. Each of these patents are entirely incorporated herein by reference. Although these patents disclose oil reconditioning systems which are both functional and effective, new systems and methods would be desirable to improve efficiency and reliability.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Approximately atmospheric pressure” means a pressure within the housing of the oil reconditioning system which is retained at a sufficiently low pressure in comparison to the pressurized oil stream initially supplied to the housing that the pressure in the housing does not substantially interfere with the formation of a mist from the oil stream when the oil stream is discharged from the oil distributor.

“Contaminants” means any particles or chemicals whose presence in the oil stream may be detrimental to the operation of the engine, such as but not limited to water, non-oil particles, sludge, fuel, and low boiling point volatiles.

“Mist” means a cloudlike aggregation of minute globules of liquids and particles, such as oil, water, and contaminants, suspended in air while moving from the oil distributor to the evaporation surface.

“Evaporation surface” means any surface configured to receive the oil stream at or near an upper portion of the surface and configured to allow the oil to flow in a film toward a lower portion of the surface, and being capable of passing heat to the film from a heat source in contact with or near the surface.

### SUMMARY OF THE INVENTION

The present invention provides a system and method for refining oil. In one preferred system, an oil purifier for an internal combustion engine may be provided for separating contaminants in an oil stream from the oil. The system may include a housing, an oil distributor, and a heating element. The housing may enclose a platen having an evaporation surface. The oil distributor may also be located in the housing and may be configured to receive an incoming oil stream. The oil distributor may have a discharge manifold for transforming the oil stream into a mist. The mist may be directed toward, and distributed over, at least a portion of the evaporation surface. The heating element may be in thermal communication with the platen. The evaporation surface may be heated to a temperature sufficient to volatilize the contaminants, resulting in a purified liquid oil which may be collected and reused with the engine.

In an additional preferred embodiment, the heating element is in physical contact with the platen. In an additional embodiment, the evaporation surface includes an upper portion which receives the oil mist and upon which the oil forms a film, and a lower portion which receives the oil film flowing toward it under the influence of gravity and from which the purified liquid oil is collected.

In an additional preferred embodiment, the evaporation surface includes an inverse substantially conical shape having a plurality of substantially planar downwardly sloping sides. In an additional preferred embodiment, the evaporation surface lacks horizontal surfaces between the upper portion and the lower portion. In an additional preferred embodiment, the primarily planar side portions include horizontal grooves. In an additional preferred embodiment, the plurality of substantially planar side portions converge at transition points, and at least one of the transition points is rounded.

In an additional preferred embodiment, the contaminants are discharged to the atmosphere and/or to the engine manifold. In an additional preferred embodiment, the liquid oil is collected and returned to an oil fill associated with the engine. In an additional preferred embodiment, a gap is provided between the platen and a bottom plate of the housing, and the liquid oil is collected on the bottom plate. In an additional preferred embodiment, the platen extends to a bottom plate of the housing, thereby separating the housing into an inner chamber and an outer chamber, and the liquid oil remains in the inner chamber.

In an additional preferred additional embodiment, the oil purifier also includes a metering jet for regulating the oil stream prior to the oil stream being introduced to the oil distributor.

In an additional preferred additional embodiment, the oil purifier also includes a three-stage filter configured to remove particles greater than three microns from the oil stream prior to the oil stream being introduced to the oil distributor.

In an additional preferred additional embodiment, the housing is maintained at approximately atmospheric pressure and the distributor is configured to receive the oil stream at greater than atmospheric pressure.

In another preferred embodiment, the system may include a housing, an oil distributor, a three-stage filter, and a heating element. The housing may enclose a platen having an evaporation surface. The oil distributor may also be located in the housing and may be configured to receive an incoming oil stream and to direct the oil over at least a portion of the evaporation surface. The heating element may be in thermal communication with the platen. The three stage filter may remove particles from the oil stream prior to the oil stream being introduced to the oil distributor. The first stage of the filter may be exterior to the second stage and configured to remove particles between about 25-40 microns. The second stage of the filter may be exterior to the third stage and configured to remove particles between about 10-25 microns. The third stage of the filter may be configured to remove particles greater than 3 microns. The evaporation surface may be heated to a temperature sufficient to volatilize the contaminants, resulting in a purified liquid oil which may be collected and reused with the engine.

In one preferred method of practicing the invention a method of separating contaminants from an oil stream associated with an internal combustion engine is provided. The method may include the steps of introducing a contaminated oil stream from the engine to an oil distributor; transforming the contaminated oil stream to a mist; distributing the mist over an upper portion of an evaporation surface located in a housing; heating the evaporation surface; discharging the contaminants from the housing; collecting the purified oil from a lower portion of the evaporation surface; and reintroducing the purified oil to the engine.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a diagrammatic view illustrating a lubricating system employing an embodiment of the oil purifier of the present invention which includes a purifier filter and a purifier chamber;

FIG. 2 is a sectional view of the purifier chamber of FIG. 1, including a flow platen;

FIG. 3 is a sectional view of the flow platen of FIG. 2; and

FIG. 4 is a block diagram of a preferred embodiment of a process of practicing the present invention.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF PREFERRED EMBODIMENTS

Set forth below is a description of what are believed to be the preferred embodiments and/or best examples of the invention claimed. Future and present alternatives and modifications to the preferred embodiments are contemplated. Any alternatives or modifications which make insubstantial changes in function, in purpose, in structure, or in result are intended to be covered by the claims of this patent.

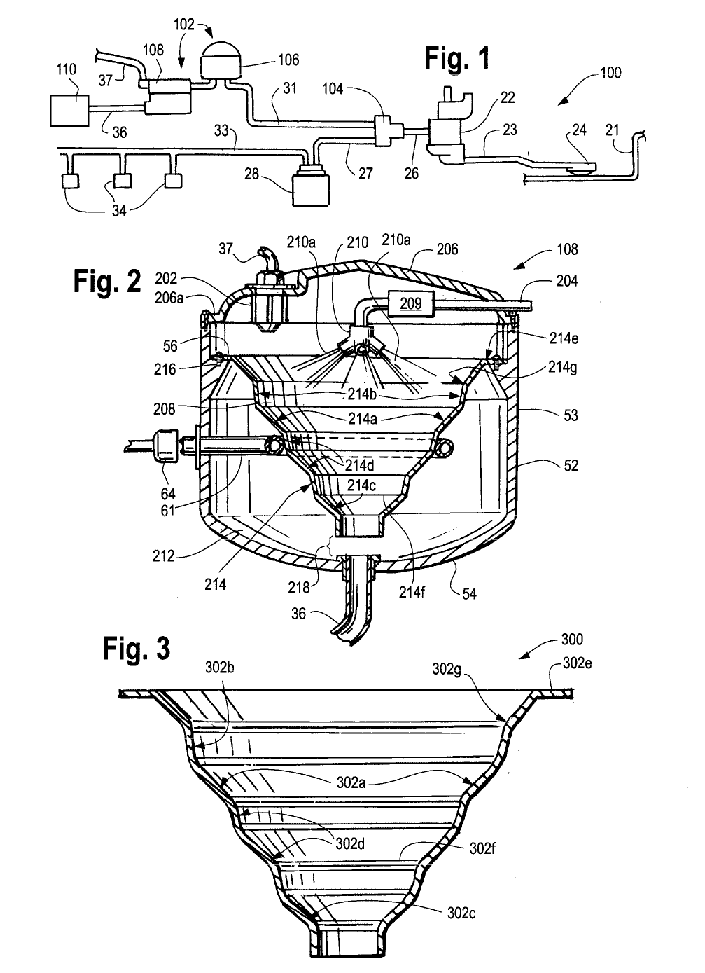

FIG. 1 shows a lubricating system 100 employing a preferred embodiment of oil purifier 102 of the current invention. In lubricating system 100, lubricating oil that has drained and collected in an oil pan 21 may be withdrawn by an engine lubricating oil pump 22 connected to conduit 23. Conduit 23 may be associated with a lubricating oil screen structure 24 that may be located in the oil pan 21. From pump 22, the oil may be passed to a main lubricating oil stream successively through respective conduits 26 and 27 and into a replaceable oil filter 28 or the like.

In filter 28, the pressurized oil stream from conduit 27 may be filtered to remove filterable contaminants, such as particulates and sludge. The filtered oil may pass into a conduit system 33 through which it may be conveyed to engine bearings 34 for lubrication purposes. From the bearings 34, the oil may drain (not detailed in FIG. 1) and may again collect in the oil pan 21 for recycling through pump 22. For a description of conventional portions of system 100, see U.S. Patent Publication 2005/0040077 to DePaul, which is entirely incorporated herein by reference.

A by-pass valve or proportional flow divider 104 may be placed between conduits 26 and 27. The flow divider 104 may separate the oil stream into a main oil stream in conduit 27 and a bypass oil stream that may be introduced to conduit 31. The flow divider 104 may include a number of passageways, or holes, for accurately regulating the amount of oil entering the bypass oil stream. The bypass oil stream that enters and flows through conduit 31 may be introduced to oil purifier 102. Oil purifier 102 may include a purifier filter 106 and a purifier chamber 108.

The invention is not limited to any particular engine application. As non-limiting examples, the invention may be used with automobile engines, marine engines, truck engines, construction equipment engines, recreational vehicle engines, agricultural engines, and other types of engines, including any diesel engines that employ oil for lubricating and/or cooling. In one embodiment, the bypass oil stream may constitute particular application, in the case of a typical truck engine having approximately a 40-quart lubricating oil capacity, a 14% bypass permits sufficient oil purification through the current invention, while ensuring sufficient main oil stream flow for lubricating engine components, such as bearings 34.

Under pressure generated by pump 22, the bypass oil stream may be introduced to oil purifier 102 and may be processed as described herein, first to separate filterable contaminants and then to separate volatile, i.e. low boiling point, contaminants from the bypass oil stream. The resulting processed and purified oil may exit from oil purifier 102 through interconnecting conduit 36, which may be a 0.75-inch diameter conduit. In one embodiment, conduit 36 may allow the purified bypass oil stream to pass to oil filter 110 for the engine for recycling and reuse in engine lubrication. In another embodiment, conduit 36 may allow the purified bypass oil stream to pass into oil pan 21 (path not shown in FIG. 1).

The volatile contaminants separated from the bypass oil stream in purifier chamber 108 may be discharged from oil purifier 102 into the atmosphere through vent 202 (shown in FIG. 2), and/or into a conduit 37 for conveyance to the engine intake manifold (not shown), or otherwise, as may be desired. Vent 202 may allow vapor—such as, but not limited to, evaporated water, oil and contaminates—to exit purifier chamber 108 while restricting the flow of oil from purifier chamber 108. Vent 202 may also maintain approximately atmospheric pressure in purifier chamber 108 in order to promote evaporation of contaminates.

Oil purifier 102 may be provided for retrofitting in combination with a previously manufactured vehicular engine or the like using a kit or the equivalent. Such a kit may comprise, for example, flow divider 104, purifier filter 106, purifier chamber 108, and interconnecting conduit components, such as conduits 31 and 36.

FIG. 2 shows a sectional view of purifier chamber 108 of FIG. 1. In purifier chamber 108, contaminants, such as low boiling point volatiles, are separated from the bypass oil stream. Preliminarily, purifier filter 106 filters the bypass oil stream to remove particulates, including sludge. The filtered bypass oil stream enters purifier chamber 108 through a conduit 204 that extends in gas-tight relationship through a side portion of a top cap plate 206. The bypass oil stream is introduced to an inner chamber 208 through a metering jet 209 and an oil distributor, such as spray nozzle 210. Metering jet 209 may reduce and/or regulate the flow of the bypass oil stream, and may result in more efficient evaporation of contaminants in purifier chamber 108.

Inner chamber 208 is separated from outer chamber 212 by a platen 214 having an evaporation surface 214a. Evaporation surface 214a includes an upper portion 214b and a lower portion 214c.

As the pressurized bypass oil stream exits spray nozzle 210, the oil stream is exposed to approximately atmospheric pressure in inner chamber 208. In one embodiment, the pressure drop is approximately 75-100 psi. Spray nozzle 210 may be configured to cause the bypass oil stream to form a mist as it exits spray nozzle 210. Spray nozzle 210 may include a discharge manifold having a plurality of slits, for example 4 or 5 slits, to allow the bypass oil stream to form a plurality of mist paths 210a that may form a generally uniform distribution pattern. In one embodiment, metering jet 209 and spray nozzle 210 are configured to provide a mist over a broad circular path over the upper portion 214b of evaporation surface 214a.

The upper portion 214b of evaporation surface 214a is located to receive the oil distribution pattern from spray nozzle 210, which may be take the form of a mist and/or a stream, and to allow the oil to condense and/or deposit on upper portion 214b. In one embodiment, evaporation surface 214a is located and configured in coordination with spray nozzle 210 so that the mist is generally uniformly deposited on upper portion 214b of evaporation surface 214a where it may form a film. Contaminants within the bypass oil stream may remain in the mist and/or may be deposited on upper portion 214b with the oil film.

The top cap plate 206 may be secured to a lower housing 52. Housing 52 and cap plate 206 may be formed of cast, machined metal, and platen 214 may be formed from stamped, welded sheet metal, preferably stainless steel.

In a preferred embodiment, and referring now to FIG. 2, evaporation surface 214a may include a plurality of varying, downward-sloped surfaces 214d, which may but need not have varying slope angles from the upper portion 214b to the lower portion 214c. The varying downward-sloped surfaces 214d may converge at angled transition points 214g. Evaporation surface 214a may include a plurality of generally horizontal grooves (designated in FIG. 2 by lines 214f). Grooves 214f may beneficially reduce the speed at which the oil film travels from upper portion 214b to lower portion 214c. As the oil descends from the upper portion 214b, its exposed surface area declines, which may aid in removing volatiles from the oil being processed. Also, as the oil descends, it is concentrated at lower portion 214c, which is desirable for oil collection purposes. The shape of evaporation surface 214a is believed to result in more efficient and faster evaporation of volatiles from the oil film than previous shapes. In addition, evaporation surface 214a is believed less likely to cause undesirable pooling of oil, and formation of oil deposits, than previous shapes. An upper edge portion of platen 214 may be provided with an out-turned flange 214e. The lower housing 52 that may contain platen 214 may have generally cylindrical side walls 53 that may be joined unitarily at a bottom edge portion to a dome configured bottom plate 54. An out-turned rim flange 206a located on perimeter portions of top plate 206 may mount with machine screws or the like over, and sealingly close, with the aid of a seal (not shown), the upper edge portions of cylindrical side walls 53, thereby completing an enclosure for purifier chamber 108.

Ledge projection 56 circumferentially extends about inside wall portions of sidewalls 53 in downwardly spaced, adjacent relationship to the upper edge portions of sidewalls 53. Out-turned flange 214e rests against the flattened upper face of ledge projection 56 of evaporation surface 214. Flange 214e may be mounted to ledge projection 56 by a plurality of circumferentially spaced machine screws 216 or the like. Thus, platen 214 may divide at least the upper portion of purifier chamber 108 into an inner chamber 208 and an outer chamber 212. Preferably at the lowest point of bottom plate 54, a (e.g.) 0.75-inch drain allows the purified oil stream to exit oil purifier 102 through conduit 36.

In one embodiment, a gap 218 is left between platen 214 and bottom plate 54 in order to allow oil to pool after flowing from evaporation surface 214a. In another embodiment, the gap is omitted and platen 214 extends to bottom plate 54.

Oil that exits spray nozzle 210 as a mist may deposit on upper portion 214b of evaporation surface 214a, forming a thin film that moves downward by gravity over heated portions of evaporation surface 214. Since the evaporation surface may include surface regions defining a plurality of slope changes, the oil flowing thereover may experiences a variable flow rate and a variable film thickness as it progresses to lower portion 214c of evaporation surface 214. Such variations are generally preferred and are believed to be desirable for purposes of enhancing the separating and removing of volatile materials from the oil being so treated. It is believed that more volatile material is removed when such slope variations are employed than when evaporation surface 214a is uniformly sloped.

Volatile contaminants separated from the bypass oil stream enter inner chamber 208 and collect over platen 214 and beneath top plate 206. Conveniently and preferably, vapors collecting in inner chamber 208 are released through valve 202. In one embodiment, valve 208 includes a check valve portion to prevent loss of oil from purifier chamber 208 in the event of a blockage or hindrance of the bypass oil stream.

An electric resistance heating element 61 may be circumferentially extended around platen 214 and may be separated from inner chamber 208 by evaporation surface 214. Heating element 61 may be connected to an electrical plug type connector 62 that is associated with, and extends through, a location in side walls 53. Exteriorly relative to lower housing 52, plug type connector 62 may be conventionally connected to an electric power supply line 64. Heating element 61 may preferably be provided with a thermostatic temperature regulating means (not shown) so that at least a portion of evaporation surface 214a may be maintained at an elevated temperature. Preferably, heating element 61 is operated by a 12-volt battery, or other conventional power battery system, associated with a vehicle in which oil purifier 102 is being used. Since heating element 61 and its associated components are located on the opposite side of platen 214 from evaporation surface 214a, they may be isolated from inner chamber 208 and fluids (including oil and volatiles) therein.

As shown in FIG. 1, in one embodiment the bypass oil stream is filtered by filter 106 before being charged to purifier chamber 108. Filtering may be accomplished by a conventional filter and filter arrangements. More preferably, filtering may be accomplished through filters described in DePaul U.S. Pat. No. 6,083,406. In one preferred embodiment, a 3-stage filter 106 is employed. 3-stage filter 106 may include a first-exterior stage filter configured to filter contaminants between about 25-40 microns, a second-intermediate stage filter configured to filter contaminants between about 10-25 microns, and a third-internal stage filter configured to filter contaminants between about 3-10 microns. Filter 106 may employ an external-to-internal flow pattern such that larger particles are captured in the first-exterior and second-exterior stages, and smaller particles are captured in the third-interior stage. In one embodiment, an expanded third-interior stage is believed to provide more complete filtration and result in longer filter life.

In one embodiment, the bypass oil stream may flow at rate of about 4-to-6 gallons per hour at a pressure in the range of about 20 to about 100 psi, and preferably in the range of about 40 to about 75 psi. Preferably during the filtering, particulates having particle sizes over about 3 microns are removed. It is believed that substantially all volatile contaminants may be removed from the oil in an engine that employs the invention.

In one method of practicing the invention, a first step includes charging the pressurized and filtered bypass oil stream through spray nozzle 210 into inner chamber 208. Pressure in inner chamber 208 is preferably maintained at approximately atmospheric pressure through vent 202. Passing the pressurized and filtered bypass oil stream through spray nozzle 210 depressurizes the bypass oil stream, reduces its pressure to approximately atmospheric pressure, and generally permits the bypass oil stream to form a mist. In upper chamber 208, the oil is moved to upper portion 214b of evaporation surface 214a, where the oil generally forms a film on evaporation surface 214a. The film generally flows from upper portion 214b to lower portion 214c. Contaminants in the bypass oil stream may be volatilized through the misting process and/or through evaporation from evaporation surface 214a. The purified oil bypass stream may then be introduced to conduit 36.

In one embodiment, at least a portion of evaporation surface 214a is heated to a temperature in the range of from about 150-210° F., and more preferably about 160-200° F., although higher and lower temperatures may be used, if desired.

Those skilled in the art will readily appreciate that, particularly in the case of relatively small vehicular engines, oil purifier 102 may sometimes be employed as a replacement or alternative for a conventional oil filter assembly, such as replaceable oil filter 28, or the like.

In place of evaporation platen 214a having the shape illustrated in FIG. 1, various alternatively shaped platens may be used in various embodiments of the invention. Some of those alternative shapes are illustrated in U.S. Published Patent Application No. 2005/0040077. An alternatively shaped platen 302 is also illustrated in FIG. 3. Platen 302 may include an evaporation surface 302a having an upper portion 302b, a lower portion 302c, a plurality of downward-sloped surfaces 302d, an outturned flange 302e, and horizontal grooves 302f. The convergence of the downward sloped surfaces may have rounded edges 302g from upper portion 302b to lower portion 302c.

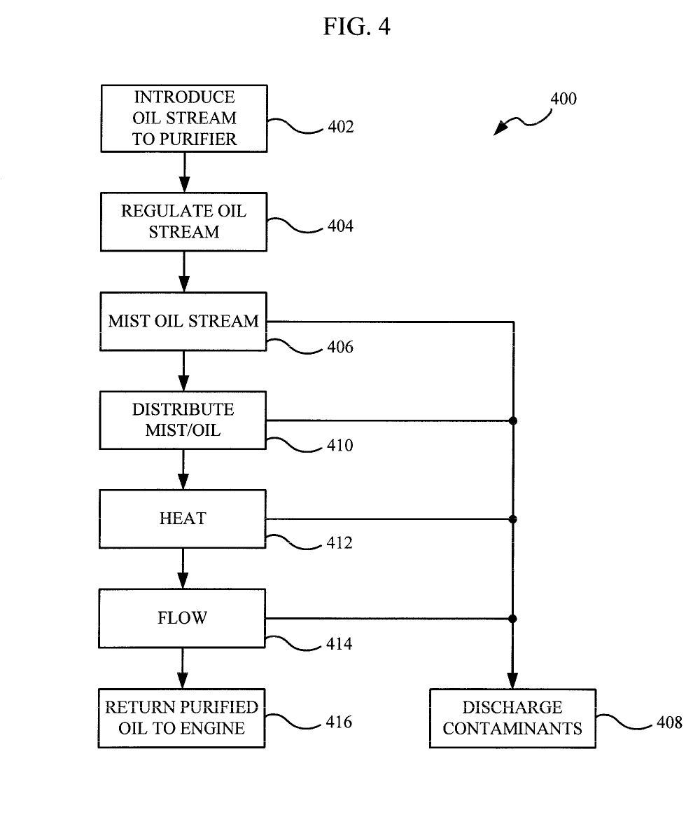

Another preferred method of practicing the invention is further illustrated in FIG. 4. FIG. 4 shows a method 400 of separating contaminants from an oil stream associated with an internal combustion engine. The method 400 may include a step 402 in which a contaminated oil stream is introduced to the purifier chamber 108. In step 404, the contaminated oil stream may be regulated through a metering jet 209. In step 406, the contaminated oil stream may be transformed into a mist, for example, by introducing the oil stream to an oil distributor such as spray nozzle 210. Various steps during the process, such as in step 406, may result in contaminants being separated from the oil stream. In step 408, contaminants may be discharged, for example, through conduit 37.

In step 410, the mist may be distributed over an upper portion of an evaporation surface located in a housing, where the oil may flow from the upper portion to a lower portion. For example, the mist may be distributed over upper portion 214b of evaporation surface 214 located in housing 52. In step 412, the evaporation surface may be heated. For example, heating element 61 may be used to heat evaporation surface 214. In step 414, the oil may flow from an upper portion of the evaporation surface to a lower portion. For example, the oil may flow from upper portion 214b to lower portion 214c. In addition to step 406, steps 410 to 414 may also result in contaminants being separated from the oil stream. In step 416, the purified oil may be collected and reintroduced to the engine. For example, the purified oil may be collected on bottom plate 54 and returned to the engine through conduit 36.

Where processes and methods are described, it is not contemplated that the steps of the method are necessarily required to be performed in the order in which they are described. The above description is not intended to limit the meaning of the words used in the following claims that define the invention. For example, while several possible designs have been described above, persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

I claim:

1. An oil purifier for an internal combustion engine for separating contaminants in an oil stream from the oil, comprising:
a housing enclosing a platen, the platen having an evaporation surface;
an oil distributor located in the housing and above the platen, the oil distributor configured to receive an incoming oil stream and having a discharge manifold configured to transform the oil stream into a mist directed toward and distributed over at least a portion of the evaporation surface; and
a heating element in thermal communication with the platen;
whereby the evaporation surface is heated to a temperature sufficient to volatilize the contaminants, resulting in a purified liquid oil which may be collected and reused with the engine.

2. The oil purifier of claim 1, wherein the heating element is in physical contact with the platen.

3. The oil purifier of claim 1, wherein the evaporation surface includes an upper portion which receives the oil mist and upon which the oil forms a film, and a lower portion which receives the oil film flowing toward it under the influence of gravity and from which the purified liquid oil is collected.

4. The oil purifier of claim 3, wherein the evaporation surface comprises an inverse substantially conical shape having a plurality of substantially planar downwardly sloping sides.

5. The oil purifier of claim 3, wherein the evaporation surface lacks horizontal surfaces between the upper portion and the lower portion.

6. The oil purifier of claim 3, wherein the primarily planar side portions include horizontal grooves.

7. The oil purifier of claim 3, wherein the plurality of substantially planar side portions converge at transition points, and at least one of the transition points is rounded.

8. The oil purifier of claim 1, wherein the contaminants are discharged to the atmosphere and/or to the engine manifold.

9. The oil purifier of claim 1, wherein the liquid oil is collected and returned to an oil fill associated with the engine.

10. The oil purifier of claim 1, wherein a gap is provided between the platen and a bottom plate of the housing, and the liquid oil is collected on the bottom plate.

11. The oil purifier of claim 1, wherein the platen extends to a bottom plate of the housing, thereby separating the housing into an inner chamber and an outer chamber, and the liquid oil remains in the inner chamber.

12. The oil purifier of claim 1, further comprising a metering jet for regulating the oil stream prior to the oil stream being introduced to the oil distributor.

13. The oil purifier of claim 1, further comprising a three-stage filter configured to remove particles greater than three microns from the oil stream prior to the oil stream being introduced to the oil distributor.

14. The oil purifier of claim 1, wherein the housing is maintained at approximately atmospheric pressure and the distributor is configured to receive the oil stream at greater than atmospheric pressure.

15. An oil purifier for an internal combustion engine for separating contaminants in an oil stream from the oil, comprising:
a housing enclosing a platen, the platen having an evaporation surface, the evaporation surface having an inverse conical shape consisting primarily of a plurality of primarily planar side portions that slope at a plurality of downward angles from an upper portion to a lower portion;
an oil distributor located in the housing and configured to receive an incoming oil stream, the oil distributor having a discharge manifold configured to direct the oil stream toward, and to distribute the oil stream over, the upper portion of the evaporation surface; and
a heating element in thermal communication with the platen;
whereby the evaporation surface is heated to a temperature sufficient to volatilize the contaminants, resulting in a purified liquid oil which may be collected from the bottom portion of the evaporation surface and reused with the engine.

16. The oil purifier of claim 15, wherein the evaporation surface comprises an inverse conical shape having a plurality of substantially planar side portions that slope at downward angles from the upper portion to the lower portion.

17. The oil purifier of claim 15, wherein the evaporation surface lacks horizontal surfaces between the upper portion and the lower portion.

18. The oil purifier of claim 15, wherein the substantially planar side portions include horizontal grooves.

19. The oil purifier of claim 15, wherein the plurality of substantially planar side portions converge at transition points, and at least one of the transition points is rounded.

20. A method of separating contaminants from an oil stream associated with an internal combustion engine, the steps comprising:
introducing a contaminated oil stream from the engine to an oil distributor;
transforming the contaminated oil stream to a mist;
distributing the mist over an upper portion of an evaporation surface located in a housing;
heating the evaporation surface;
discharging the contaminants from the housing;
collecting the purified oil from a lower portion of the evaporation surface; and
reintroducing the purified oil to the engine.

21. The method of claim 20, wherein the oil stream is at greater than atmospheric pressure when introduced to the oil distributor, and the housing is maintained at approximately atmospheric pressure.

22. The method of claim 20, further including the step of passing the contaminated oil stream through a three-stage filter configured to remove particles greater than three microns from the oil stream.

23. An oil purifier for an internal combustion engine for separating contaminants in a bypass oil stream from the oil, comprising:
a housing enclosing a platen, the platen having an evaporation surface;
an oil distributor located in the housing and above the platen, the oil distributor configured to receive an incoming bypass oil stream and having a discharge configured to direct the oil toward and distribute the oil over at least a portion of the evaporation surface; and
a heating element in thermal communication with the platen;
a three-stage filter configured to remove particles from the oil stream prior to the oil stream being introduced to the oil distributor, having the first stage exterior to the second stage and configured to remove particles between about 25-40 microns, having the second stage exterior to the third stage and configured to remove particles between about 10-25 microns, and having the third stage configured to remove particles greater than 3 microns;
whereby the evaporation surface is heated to a temperature sufficient to volatilize the contaminants, resulting in a purified liquid oil which may be collected and reused with the engine.
